(19) United States
(12) Patent Application Publication
(10) Pub. No.: US 2024/0288125 A1
(43) Pub. Date: Aug. 29, 2024

(54) PROCESS AND APPARATUS FOR RELIQUEFACTION AND RECYCLING OF BOG INTO AN LNG TANK

(71) Applicant: BURCKHARDT COMPRESSION AG, Winterthur (CH)

(72) Inventors: Adrian Luzi VALÄR, Winterthur (CH); Roman SCHROTH, Männedorf (CH)

(73) Assignee: BURCKHARDT COMPRESSION AG, Winterthur (CH)

(21) Appl. No.: 18/294,447

(22) PCT Filed: Aug. 2, 2022
(86) PCT No.: PCT/EP2022/071610

§ 371 Date: Feb. 1, 2024

(30) Foreign Application Priority Data
Aug. 2, 2021 (EP) 21189168.4

(51) Int. Cl. F17C 9/04

(52) U.S. Cl. CPC F17C 9/04; F17C 2223/0161; F17C 2223/033; F17C 2223/043; F17C 2260/046; F17C 2265/033; F17C 2265/037; F17C 2265/038

(57) ABSTRACT

Method and apparatus for reliquefying and returning boil-off gas (BOG) to a liquefied natural gas (LNG) tank, the method including: Withdrawing BOG (F2) from the headspace of an LNG tank; compressing the BOG in a first compression stage to a first pressure p₁ between 8 and 18 bara and tapping of a first portion of this gas; further compressing a second portion of the gas from step in a final compression stage to a second pressure p₂≥120 bara; cooling at least part of the further compressed gas to a first temperature T₁ between −20° C. and −100° C.; expanding the gas from step to a third pressure p₃ between 8 and 20 bara; and separating the gas from step into a liquid phase and a gaseous phase to combine the gaseous phase with the tapped first portion of the gas from the first compression stage and to return the liquid phase into the LNG tank.

The invention relates to the technical field of reliquefying boil-off gas (BOG) from a liquefied natural gas (LNG) tank.

Recently, the consumption of liquefied gas such as liquefied natural gas (LNG) has risen sharply worldwide. LNG, which is produced by cooling natural gas to an extremely low temperature, has a small volume and is therefore well suited for storage and transportation. In addition, liquefied gas, like LNG, is low in pollutants and therefore more compatible with regulatory requirements than heavy crude oil, for example.

LNG is a colorless and transparent liquid that is obtained by cooling natural gas, which consists mainly of methane, to around −163° C. However, since natural gas is liquefied at an extremely low temperature of −163° C. under normal pressure, LNG can easily vaporize if the temperature rises slightly. In an LNG storage tank, LNG is therefore continuously vaporized naturally to produce boil-off gas (BOG).

The formation of BOG means a loss of stored LNG and therefore reduces transport efficiency on an LNG tanker, for example. If BOG accumulates in a storage tank, there is also a risk that the pressure in the storage tank will rise and the tank will be damaged.

To address the problem, a method in which BOG is re-liquefied to return it to an LNG storage tank, a method in which BOG is supplied as an energy source to an internal combustion engine, such as a marine engine, and combinations thereof have been proposed.

In US2019/0351988, for example, it is proposed to supply BOG from an LNG tank to a DFDE engine, an X-DF engine or an ME-GI marine engine. At the same time, it is planned to use BOG as a refrigerant for reliquefying compressed BOG in a partial reliquefaction system (Partial Reliquefaction System, PRS).

However, this system has the disadvantage that nitrogen accumulates in the gas mixture during the reliquefaction cycles. Natural gas is a gas mixture that consists mainly of methane, but often also contains ethane, propane, butane and other hydrocarbons. Other secondary components may include hydrogen sulphide, nitrogen and carbon dioxide. Nitrogen is typically contained in natural gas in proportions of approx. 1 to 15%. Nitrogen has a boiling point of −196° C., which is significantly lower than the boiling point of methane, which passes into the gaseous phase at −161° C. As N₂ can therefore hardly be reliquefied in the common BOG reliquefaction systems, its proportion in the mixture increases over time. The quality of the natural gas decreases. In addition, a considerable part of the capacity of the compression system is used up by the increased No content and the efficiency of the system decreases noticeably.

It is therefore the object of the present invention to overcome the disadvantages of the prior art. In particular, it is the object of the present invention to provide a method for the partial reliquefaction of BOG or a partial reliquefaction system (PRS) in which the accumulation of N₂ over consecutive cycles is reduced or prevented.

The object is solved by a method having the features of claim 1 and a device having the features of claim 8.

In particular, the object is solved by a method for reliquefying and returning boil-off gas (BOG) to a liquefied natural gas (LNG) tank, comprising the steps:
a) Withdrawing BOG (F2) from the headspace of an LNG tank;
b) Compressing the BOG in a first compression stage to a first pressure p₁ between 8 and 18 bara and tapping of a first portion of this gas;
c) Further compressing a second portion of the gas from step b) in a final compression stage to a second pressure p₂≥120 bara, preferably 120 to 400 bara, particularly preferably 150 to 300 bara;
d) Cooling at least part of the further compressed gas from step c) to a first temperature T₁ between −20° C. and −100° C.;
e) Expanding the gas from step d) to a third pressure p₃ between 8 and 20 bara;
f) Separating the gas from step e) into a liquid phase and a gaseous phase to
   f₁) combine the gaseous phase with the tapped first portion of the gas from step c); and
   f₂) return the liquid phase to the LNG tank.

It has been found that such a method is particularly good at removing nitrogen from the system and that the nitrogen-enriched gas can be used for a useful purpose. In step f), the nitrogen will be almost completely in the gaseous phase. If the gaseous phase is combined with the BOG compressed to p₁ in the first compression stage (step c), it can be used to reliably operate a low-pressure gas injection engine.

The method further has the advantage that flash gas is generally extracted from the reliquefaction system PRS instead of compressing it again. This reduces the load on the first compression stage compared to conventional systems. It can be smaller in size and/or operated more efficiently. Overall, the energy consumption is reduced.

The further compression of a second portion of the gas from step b) in a final compression stage to a second pressure p₂ with subsequent cooling (step d)) and isenthalpic expansion (step e)) serves to efficiently reliquefy the gas, partly using the Joule-Thomson effect. With the second pressure p₂ a relatively high pressure is aimed for, so that after the usual water cooling to T_{w} a highly compressed gas at approx. 35-45° C. with a correspondingly low enthalpy is obtained. Through further cooling steps and isenthalpic expansion e) of the gas, the compressed gas can be brought to the temperature initially at T₁ with expansion to pressure p₃ to even lower temperatures, i.e. to a state that is favorable for phase separation.

It is preferred if, in the method as described above, cooling in step d) is carried out at least partially by heat exchange, preferably indirect heat exchange, with cooling BOG (F2) from the headspace of the LNG tank. It is possible to carry out one or more cooling steps of the method as described with the aid of a separate cooling circuit with a corresponding refrigerant, typically N₂. However, this is costly and energy intensive. By contrast, coolant at temperatures just above the boiling point of LNG is already present in the system as BOG.

In a preferred embodiment, the liquid phase is cooled to a temperature T₂ between −140 and −161° C. in sub-step f₂) before being returned to the LNG tank. This reduces the formation of new BOG. Preferably, this cooling is achieved by heat exchange in counterflow to BOG from the LNG tank. In this way, the existing cooling capacity is optimally utilized. Before or when feeding the liquid phase into the LNG tank, the reliquefied gas is finally expanded to an ambient pressure of 1 bara.

If, as described above, cooling is carried out both in step f₂) and in step d) by heat exchange, preferably indirect heat exchange, with cooling BOG from the headspace of the LNG tank, it is expedient if the particularly cold BOG taken directly from the LNG tank is used for cooling in sub-step f₂) and the BOG is then used for cooling in step d) at an already slightly higher temperature.

In a particularly preferred embodiment, cooling in step d) is carried out at least partially by heat exchange with the gaseous phase from step f). After phase separation, the gaseous phase has a pressure p₃ and typically a temperature around −80° C. Since the gaseous phase is intended for use in a low-pressure gas injection engine, such low temperatures and often such high pressures are not required. The gaseous phase can therefore be used as a refrigerant in a cooling process. By further expanding the gaseous phase from step f) before using it as a coolant, the temperature can be lowered further using the Joule-Thomson effect.

It is particularly preferred if the gaseous phase from step f) and the BOG from the headspace of the LNG tank are both used as coolant in step d), but the gaseous phase from step f) is used for pre-cooling the warmer compressed gas, while the BOG from the LNG tank is used for cooling the already pre-cooled compressed gas. In such an arrangement, the gas compressed to p₂ and typically present at temperatures well above 100° C. is first cooled to approx. 35-45° C. by water cooling, then cooled to intermediate temperatures of approx. 25 to −15° C. in heat exchange with the gaseous phase from step f) and further downstream cooled to the temperature T₁ between −20 and −100° C. by heat exchange with cooling BOG from the LNG tank. Through this sequence of heat exchange steps, the existing cooling capacity of BOG and compressed gas is used to optimize the use of the cooling capacity available in the system.

It is preferred if, in step d), a portion of the further compressed gas from step c) is fed to a supply line for a high-pressure gas injection engine (2). In this embodiment, the highly compressed gas at pressure p₂ can be used to drive a high-pressure gas injection engine or can alternatively be reliquefied. Natural gas is the fuel of choice, particularly on a liquefied gas tanker, in order to keep the emission of air pollutants to a relatively low level. The adjustability of the quantity that is fed to the gas injection engine or into the PRS allows the climatic and meteorological conditions as well as the fuel requirements of the high-pressure gas injection engine to be flexibly taken into account.

In a preferred embodiment, the pressure p₃ is monitored and controlled in step f) so that it has a value within a predetermined range. This can be achieved by means of a pressure sensor. The measured value makes it possible to optimize the conditions in the gas-liquid separator and, if necessary, to adjust the LNG delivery rate. Additionally or alternatively, a volume of the liquid phase can be monitored in step f) in order to regulate the return quantity into the LNG tank depending on the value.

A further aspect of the invention relates to an apparatus for reliquefying and returning boil-off gas (BOG) into a liquefied natural gas (LNG) tank comprising
a first heat exchanger, comprising a line for passing through cooling fluid, preferably BOG from an LNG tank, and a line for passing through compressed gas to be cooled, preferably in counterflow;
a multi-stage compressor comprising at least a first compression stage and a final compression stage, wherein the first compression stage is configured to compress BOG (F2) from the LNG tank to a first pressure p₁ between 8 and 18 bara, and wherein the final compression stage is configured to compress pre-compressed BOG to a second pressure p₂≥120, preferably 120 to 400 bara, particularly preferably 150 to 300 bara;
a branch line which is arranged downstream of the first compression stage in a fluid-conducting manner and which opens further downstream into a supply line for a low-pressure gas injection engine and/or a gas combustion unit;
a return line;
a first expansion unit configured to expand compressed gas from a second pressure p₂ to a third pressure p₃, wherein p₃ is between 8 and 20 bara, preferably between 10 and 18 bara;
a gas-liquid separator configured to separate a liquefied gas portion for feeding back into the LNG tank (3) at a pressure p₃ and to feed a gaseous portion into a bypass line, the bypass line opening into the branch line;

wherein the multi-stage compressor is connected upstream in a fluid-carrying manner to the headspace of the LNG tank, preferably via the line of the heat exchanger for passing through cooling BOG, and wherein the multi-stage compressor is connected downstream in a fluid-carrying manner via the return line to the line of the first heat exchanger for passing through compressed gas to be cooled, is connected further downstream to the first expansion unit, and is connected still further downstream to the gas-liquid separator; and wherein the first heat exchanger is in particular configured to cool at least a portion of the BOG further compressed to the second pressure p₂ to a first temperature T₁ between −20° C. and −100° C.

Such an apparatus is capable of carrying out a method according to the invention. The nitrogen present in the natural gas accumulates in the gaseous phase of the gas-liquid separator, is removed from the system and put to a useful purpose as a fuel mixture. Via the bypass line, the gaseous phase can be combined with the BOG compressed to p₁ in the first compression stage, thus ensuring a reliable supply of fuel to the low-pressure gas injection engine. In general, the apparatus according to the invention allows flash gas from the reliquefaction cycle to be removed from the system instead of compressing it repeatedly, which relieves the multi-stage compression system, in particular the first compression stage, and enables a smaller design.

The first compression stage can comprise one or more piston compressors, each with subsequent water cooling. The same applies to each higher compression stage. It is preferable if the final compression stage is also followed by water cooling. In this way, highly compressed LNG can be provided at a pressure p₂ and a temperature of approx. 35-45° C., which is well suited for treatment in the reliquefaction system PRS.

The low-pressure gas injection engine, which is supplied with fuel through the supply line, typically uses gas at a pressure of approx. 6 to 18 bara, preferably at a pressure of around 6 bara. As the pressure p₁ in the branch line can be higher than this target pressure, a throttle valve can be provided between the branch line and the supply line to relieve the pressure of the gas.

The expansion unit can be an expansion valve or an expander. During expansion, the Joule-Thomson effect is used to further reduce the temperature in the gas to be reliquefied. As the pressure p₃ in the gas-liquid separator can be higher than the pressure p₂ in the branch line, the bypass line can also have an expansion unit.

In a preferred embodiment, the apparatus described above comprises a second heat exchanger, having a line for passing through cooling fluid, preferably BOG from an LNG tank, and a line for passing through compressed gas to be cooled, preferably in counterflow, wherein, in the second heat exchanger, the line for passing through compressed gas to be cooled is arranged in a fluid-carrying manner between the gas-liquid separator and the LNG tank, and wherein preferably the line for passing through cooling fluid is arranged in a fluid-carrying manner between the headspace of the LNG tank and the first heat exchanger. With the aid of the second heat exchanger, the particularly cold BOG can be used to cool the reliquefied gas immediately after it escapes, while the already slightly warmed BOG is used as a coolant in a cooling stage downstream of the water-cooling system but upstream of the gas-liquid separator. The targeted use of BOG as a coolant in different sections of the PRS increases the overall reliquefaction rate.

It is preferable if the device comprises a third heat exchanger whose cooling line is part of the bypass line and whose line to be cooled is part of the return line. This means that the gaseous phase isolated in the gas-liquid separator, which has a pressure p₃ and a temperature of around −82° C., can initially be used as a refrigerant and used downstream as fuel for a low-pressure gas injection engine. A further expansion unit can be arranged between the gas outlet of the gas-liquid separator and the third heat exchanger. By further expanding the gaseous phase from step f) before using it as a coolant, the temperature can be further reduced using the Joule-Thomson effect.

It is preferred if the device further comprises a second expansion unit configured to expand compressed gas from a third pressure p₃ to atmospheric pressure, wherein the second expansion unit is arranged in a fluid-conducting manner between the liquid outlet of the gas-liquid separator and the LNG tank, preferably between the conduit of the second heat exchanger for passing through compressed gas to be cooled and the LNG tank.

After the gas-liquid separator, the liquid phase is typically at a pressure p₃ and a temperature of around −110° C. After cooling in the second heat exchanger to around −155° C., the reliquefied gas can be expanded again in a further expansion unit, for example to atmospheric pressure, and particularly low temperatures around the boiling point of natural gas can be achieved.

The device can be part of a fuel gas supply system for supplying a high-pressure gas injection engine with gas stored in the LNG tank, additionally comprising an outlet which is arranged downstream of the second compression stage of the multi-stage compressor in a fluid-conducting manner and opens further downstream into a supply line for a high-pressure gas injection engine, wherein the compressed gas, insofar as the quantity exceeds the fuel requirement of the high-pressure gas injection engine, can be fed to the return line, in particular from the outlet.

In this embodiment, the highly compressed gas at pressure p₂ can either be used to drive a high-pressure gas injection engine or be reliquefied in the PRS. Natural gas can also be used to drive the transport vehicle, for example. Natural gas is the fuel of choice, particularly on a liquefied gas tanker, in order to keep the emission of air pollutants to a relatively low level. The adjustability of the quantity fed to the gas injection engine or into the PRS makes it possible to respond flexibly to climatic and meteorological conditions as well as the fuel requirements of the high-pressure gas injection engine.

One aspect of the invention relates to an apparatus as described above, wherein the gas-liquid separator has a pressure sensor to measure the pressure in the gas-liquid separator, and a controller to actuate a valve arranged between a gas outlet of the gas-liquid separator and the bypass line as a function of the measured pressure. The apparatus as described above can be designed in such a way that the gas-liquid separator has a level sensor and a control unit to actuate a valve arranged between a liquid outlet of the gas-liquid separator and the LNG tank as a function of the measured level. The pressure and the liquid level in the gas-liquid separator can be regulated via the valves by means of a corresponding control system.

The invention further relates to the use of an apparatus as described above on a ship, in particular a ship propelled by means of a high-pressure gas injection engine. In view of the limited space available on the ship, it is particularly helpful if the compression stages of the multi-stage compressor can be made smaller thanks to the increased efficiency and the continuous extraction of the N₂ component from the LNG.

The invention is further explained by means of figures. The figures are for illustrative purposes and are not to be understood as limiting.

It shows:

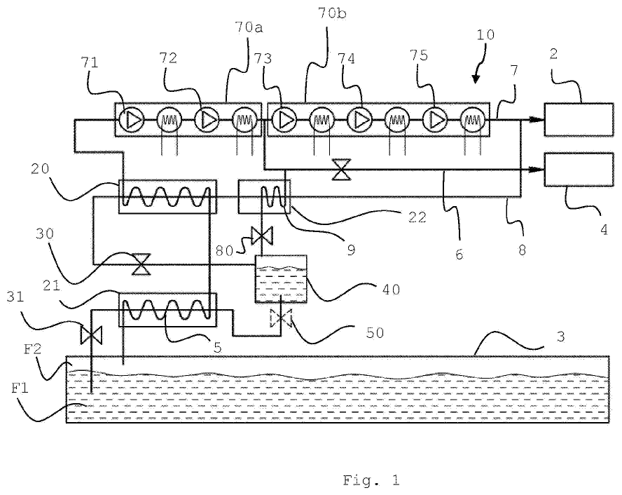

FIG. 1 Schematic representation of an apparatus according to the present invention;

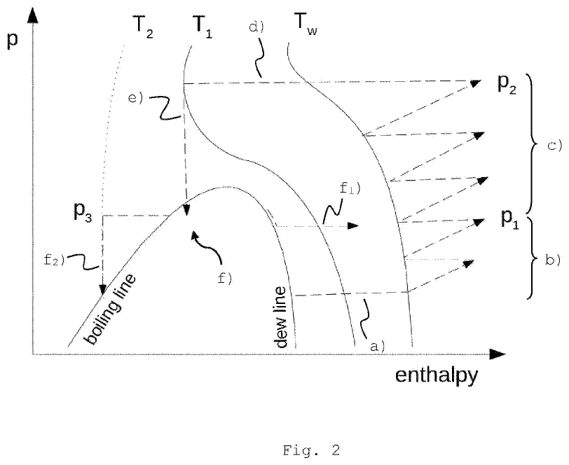

FIG. 2 Schematic Mollier diagram illustrating a method according to the present invention.

FIG. 1 is a schematic representation of an apparatus for reliquefying and returning boil-off gas (BOG) to a liquefied natural gas (LNG) tank. The BOG F2 is removed from the LNG tank 3 at approx. −161° C. and initially fed to the second heat exchanger 21, where it is passed as a cooling fluid through line 5 in counterflow to the reliquefied gas to be cooled. Further downstream, the BOG is fed to a first heat exchanger 20, namely a line for passing cooling fluid, in counterflow to compressed gas to be cooled. The BOG thus heated to temperatures of approximately 30° C. is then fed to a multi-stage compressor 10 and compressed in a first compression stage 70a. Preferably, the first compression stage has one or two piston compressors 71, 72 connected in parallel or in series, each with subsequent water cooling. The first compression stage 70a is set up to compress the BOG to a first pressure p₁ of, for example, 12 bara. After the first compression stage 70a, a branch line 6 is arranged downstream in a fluid-conducting manner, which opens further downstream into a supply line for a low-pressure gas injection engine 4. The gas can be depressurized to the pressure required by the gas injection engine 4, for example 6 bara, by a valve arranged on the branch line 6. The figure shows that the multistage compressor arrangement 10 has a second compression stage, which is also the final compression stage 70b. The final compression stage 70b is configured to compress pre-compressed BOG to a second pressure p₂ of approx. 300 bara. This is achieved by means of three piston compressors 73, 74, 75, each with subsequent water cooling. However, a different number or type of compressors can also be used and they can be connected in parallel or in series.

Downstream of the multi-stage compressor arrangement 10, a fluid-conducting outlet 7 is arranged on the one hand, which opens into a supply line for a high-pressure gas injection engine 2. On the other hand, a return line 8 is arranged, the contents of which are indirectly cooled further downstream—among other things—to a temperature of approx. −70° C. using the first heat exchanger 20. As a result, the compressed gas can be fed to the return line 8 if the quantity exceeds the fuel requirement of the high-pressure gas injection engine 2. Further downstream of the first heat exchanger 20, a first expansion unit 30 is connected, which is set up to expand the compressed and cooled gas is enthalpically from the pressure p₂ to a third pressure p₃ of approx. 15 bara, whereby the temperature is further reduced to approx. −110° C.

A gas-liquid separator 40 is connected downstream of the expansion unit 30, which is set up to separate a liquefied gas portion for feeding back into the LNG tank 3 at pressure p₃ and to feed a gaseous portion into a bypass line 9, the bypass line 9 opening into the branch line 6. It can be seen from FIG. 1 that the exemplary device comprises a third heat exchanger 22, the cooling line of which is part of the bypass line 9 and the line to be cooled is part of the return line 8, the latter part corresponding to a section of the return line upstream of the first heat exchanger 20. Based on the embodiment shown, the highly compressed, water-cooled BOG from the last compression stage 70b is first cooled in indirect heat exchange with the gaseous phase from the gas-liquid separator before and then further cooled in indirect heat exchange with the BOG from the LNG tank before expansion and phase separation takes place.

The liquid phase leaves the gas-liquid separator 40 and is indirectly cooled further in the second heat exchanger 21 to a temperature T₂ of only around −155° C. using BOG, which was fed directly from the LNG tank and into a cooling fluid jacket 5. Finally, the liquid is expanded to atmospheric pressure in the expansion unit 31 and returned to the LNG tank.

The valves 80 and 31, respectively 50, serve to control the pressure and liquid level in the gas-liquid separator 40. They can be actuated as a function of a pressure and/or level measured in the gas-liquid separator. Optionally, a valve can also be arranged between the outlet of the gas-liquid separator 40 and the line of the second heat exchanger 21 for the passage of fluid to be cooled in order to control the fill level in the gas-liquid separator.

FIG. 2 shows a schematic Mollier diagram to illustrate a method according to the present invention. The x-axis shows the enthalpy of the system, the y-axis the pressure of the gas. Certain temperatures are shown as isothermal lines T_{w}, T₁ and—dotted—T₂; likewise the boiling line and dewline. The method steps that are associated with a change in enthalpy, temperature and/or pressure are shown as dashed lines.

In step a), the BOG is withdrawn from the headspace of the LNG tank and heated to a temperature T_{w} by ambient temperature but also by using it as a coolant in one or more heat exchangers. In step b, the BOG is compressed to a first pressure p₁ of between 8 and 18 bara in a first compression stage, in this case comprising two compression operations with subsequent water cooling, and a first portion of this gas is tapped (not shown). In step c), the gas is further compressed to a high pressure p₂ in a final compression stage, in this case consisting of three compression operations, each with subsequent water cooling. This is followed in step d) by the cooling of at least part of the further compressed gas from step c), initially by means of water cooling to T_{w} and then to a first temperature T₁ between −20° C. and −100° C. Step e) is followed by isenthalpic expansion to a third pressure p₃ between 8 and 20 bara. Step f) follows with the separation of the gas into a liquid and a gaseous phase in order to combine the gaseous phase with the diverted first part of the gas from step b) (sub-step f₁) and to return the liquid phase to the LNG tank 3 (sub-step f₂).

FIG. 2 shows that in sub-step f₂) the liquid phase is further cooled to a temperature T₂ that is only slightly above the boiling point of natural gas before being returned to the LNG tank at ambient pressure, which corresponds to the cooling in the second heat exchanger 21 in FIG. 1. In sub-step f₁) it can also be seen that the gaseous phase can be further expanded and/or heated again before combining with the pre-compressed BOG from the first compression stage b), for example in indirect heat exchange with compressed gas to be cooled, which corresponds to its use as a refrigerant in the heat exchanger 22 of FIG. 1.

1. A method for reliquefying and returning boil-off (BOG) to a liquefied natural gas (LNG) tank, comprising the steps of:
a) withdrawing BOG from the headspace of an LNG tank;
b) compressing the BOG in a first compression stage to a first pressure p₁ between 8 and 18 bara and tapping of a first portion of this gas;
c) further compressing a second portion of the gas from step b) in a final compression stage to a second pressure p₂≥120 bara;
d) cooling at least part of the further compressed gas from step c) to a first temperature T₁ between −20° C. and −100° C.;
e) expanding the gas from step d) to a third pressure p₃ between 8 and 20 bara;
f) separating the gas from step e) into a liquid phase and a gaseous phase to
f₁) combine the gaseous phase with the tapped first portion of the gas from step c);
and
f₂) return the liquid phase to the LNG tank.

2. The method according to claim 1, wherein in step f₂) the liquid phase before being returned to the LNG tank
is cooled to a temperature T₂ between −140 and −161° C.

3. The method according to claim 1, wherein the cooling in step d) is carried out at least partly by heat exchange with cooling BOG from the headspace of the LNG tank.

4. The method according to claim 1, wherein the cooling in step d) is carried out at least partly by heat exchange with the gaseous phase from step f).

5. The method according to claim 1, wherein in step d) a portion of the further compressed gas from step c) is fed to a supply line for a high-pressure gas injection engine.

6. The method according to claim 1, wherein in step f) the pressure p₃ is monitored and controlled so that it has a value within a predetermined range.

7. The method according to claim 1, wherein in step f) a volume of the liquid phase is monitored in order to regulate the return quantity into the LNG tank as a function of the value.

8. An apparatus for reliquefying and returning boil-off gas (BOG) into a liquefied natural gas (LNG) tank comprising
a first heat exchanger comprising a line for passing through cooling fluid and a line for passing through compressed gas to be cooled;
a multi-stage compressor comprising at least a first compression stage and a final compression stage, the first compression stage being configured to compress BOG from the LNG tank to a first pressure p₁ between 8 and 18 bara and wherein the final compression stage is configured to compress pre-compressed BOG to a second pressure p₂≥120 bara;
a branch line which is arranged downstream of the first compression stage in a fluid-conducting manner and which opens further downstream into at least one of a supply line for a low-pressure gas injection engine and a gas combustion unit;
a return line;
a first expansion unit configured to expand compressed gas from a second pressure p₂ to a third pressure p₃, wherein p₃ is between 8 and 20 bara;
a gas-liquid separator configured to separate a liquefied gas portion for feeding back into the LNG tank at a pressure p₃ and to feed a gaseous portion into a bypass line, the bypass line opening into the branch line;
wherein the multi-stage compressor is connected upstream in a fluid-carrying manner to the headspace of the LNG tank, and wherein the multi-stage compressor is connected downstream in a fluid-carrying manner via the return line to the line of the first heat exchanger for passing through compressed gas to be cooled, is connected further downstream to the first expansion unit, and is connected still further downstream to the gas-liquid separator.

9. The apparatus according to claim 8, further comprising
a second heat exchanger, having a line for passing through cooling fluid, and a line for passing through compressed gas to be cooled;
wherein in the second heat exchanger the line for passing through compressed gas to be cooled is arranged in a fluid-conducting manner between the liquid outlet of the gas-liquid separator and the LNG tank.

10. The apparatus according to claim 8, further comprising
a third heat exchanger, the cooling line of which is part of the bypass line and the line to be cooled is part of the return line.

11. The apparatus according to claim 8, further comprising
a second expansion unit configured to expand compressed gas from the third pressure p₃ to atmospheric pressure,
wherein the second expansion unit is configured to conduct fluid between the liquid outlet of the gas-liquid separator and the LNG tank.

12. The apparatus according to claim 8, wherein the apparatus is part of a fuel gas supply system for supplying a high-pressure gas injection engine with gas stored in the LNG tank, additionally comprising
an outlet which is arranged downstream of the second compression stage of the multi-stage compressor in a fluid-conducting manner and opens further downstream into a supply line for a high-pressure gas injection engine,
whereby the compressed gas, insofar as the quantity exceeds the fuel requirement of the high-pressure gas injection engine, can be fed to the return line.

13. The apparatus according to claim 8, wherein the gas-liquid separator comprises a pressure sensor to measure the pressure in the gas-liquid separator, and a controller to actuate a valve arranged between a gas outlet of the gas-liquid separator and the bypass line as a function of the measured pressure.

14. The apparatus according to claim 8, wherein the gas-liquid separator comprises a level sensor and a controller to actuate a valve arranged between a liquid outlet of the gas-liquid separator and the LNG tank as a function of the measured level.

15. (canceled)

16. The method according to claim 2, wherein cooling of the liquid phase is carried out by heat exchange with cooling BOG from the headspace of the LNG tank.

17. The apparatus according to claim 8, wherein the cooling fluid is BOG from an LNG tank.

18. The apparatus according to claim 8, wherein the first heat exchanger is configured for heat exchange between the line for passing through cooling fluid and the line for passing through compressed gas to be cooled in counterflow.

19. The apparatus according to claim 8, wherein the multi-stage compressor is connected upstream in a fluid-carrying manner to the headspace of the LNG tank via the line of the heat exchanger for passing through cooling BOG.

20. The apparatus according to claim 9, wherein the line for passing through cooling fluid is arranged in a fluid-conducting manner between the head space of the LNG tank and the line of the first heat exchanger for passing through cooling fluid.

21. The apparatus according to claim 11, wherein the second expansion unit is configured to conduct fluid between the line of the second heat exchanger for passing through compressed gas to be cooled and the LNG tank.
